(19) United States
(12) Patent Application Publication
(10) Pub. No.: US 2025/0158988 A1
(43) Pub. Date: May 15, 2025

(54) DATA PROVISIONING USING APPLICATION PROGRAMMING INTERFACES

(71) Applicant: Wells Fargo Bank, N.A., San Francisco, CA (US)

(72) Inventors: Vijay Anusuri, Charlotte, NC (US); Ramesh H. Joshi, Charlotte, NC (US); Sameer M. Joshi, Charlotte, NC (US); Suresh Kumar, Charlotte, NC (US); Ashish Lahoti, Round Rock, TX (US); Cedric Lamielle, Scottsdale, AZ (US); Lakshmikanth Nagapudi, Waxhaw, NC (US); Hargurjit S. Malhi, Cave Creek, AZ (US)

(21) Appl. No.: 18/051,176

(22) Filed: Oct. 31, 2022

(51) Int. Cl. H04L 9/40; G06F 9/54; G06Q 30/0601

(52) U.S. Cl. CPC H04L 63/10; G06F 9/547; G06Q 30/0641

(57) ABSTRACT

An example computer system for provisioning data can include: one or more processors; and non-transitory computer-readable storage media encoding instructions which, when executed by the one or more processors, causes the computer system to create: a marketplace programmed to provide a plurality of application programming interfaces (APIs) for available data sources, the APIs being subscribable for client devices; and an authentication engine programmed to control access by the client devices to the APIs in the marketplace.

### BACKGROUND

Data flows through many devices in a large system. Over time, the paths data take from one device to another can become convoluted and difficult to manage. This can result in a spaghetti-work of pathways that are challenging to maintain, particularly when changes are made to the devices within the pathways. This can result in a less-than-efficient system that requires upkeep to keep data flowing from the desired sources to destinations.

### SUMMARY

Examples provided herein are directed to data provisioning.

According to one aspect, an example computer system for provisioning data can include: one or more processors; and non-transitory computer-readable storage media encoding instructions which, when executed by the one or more processors, causes the computer system to create: a marketplace programmed to provide a plurality of application programming interfaces (APIs) for available data sources, the APIs being subscribable for client devices; and an authentication engine programmed to control access by the client devices to the APIs in the marketplace.

According to another aspect, an example method for provisioning data can include: providing a marketplace programmed to include a plurality of application programming interfaces (APIs) for available data sources, the APIs being subscribable for client devices; and controlling access by the client devices to the APIs in the marketplace.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for data provisioning.

FIG. 2 shows an example of data provisioning for a client device of the system of FIG. 1.

FIG. 3 shows example logical components of a server device of the system of FIG. 1.

FIG. 4 shows an example graphical user interface generated by the server device of FIG. 3.

FIG. 5 shows another example graphical user interface generated by the server device of FIG. 3.

FIG. 6 shows example physical components of the server device of FIG. 3.

### DETAILED DESCRIPTION

This disclosure relates to data provisioning.

In some examples provided herein, the data provisioning can include a data Application Programming Interface (API), which provides a standardized process to consume data from data repositories. These APIs can be discoverable from one or more subscription marketplaces, be integrated with data governance, and/or make data more accessible.

In the examples provided herein, the data APIs can provide technology abstraction, which is an abstraction layer that isolates data sources. This allows the system to seamlessly move data hosting platforms without impacting the consumers of the data, such as by providing the ability for cloud migration.

In addition, the example data API provisioning can implement governance controls and other security, thereby providing data consumers with assurances that the provided data is from an authorized source and has been approved for consumption. Further, consumers are provided with easy access to the data for integration through the list of APIs exposed via the marketplace, as described below.

Further, data Producers can visualize usage through dashboards, allowing API usage to be monitored across multiple consumers. This can provide a holistic view of data usage across an entire system.

There can be various advantages associated with the technologies described herein. For instance, the data API provisioning can result in simplified data flows across the system by reducing redundant and inefficient point-to-point data flows. Further, the data API provisioning allows for the integration of management and governance provisions, thereby enhancing data control and integrity. Further, the data API provisioning can provide an easier mechanism for sharing and consuming data and reduce the complexity of the paths through which the data flows.

Such advantages can lead to cost savings and reductions in complexities. Further, data integrity and security are increased, and fewer technologies need be leveraged to accomplish a robust marketplace for transmission and consumption of the data. Finally, there can be one or more of improved discoverability of existing data stores, enforcement of data sharing agreements, and/or input of metadata information and lineages associated with the data.

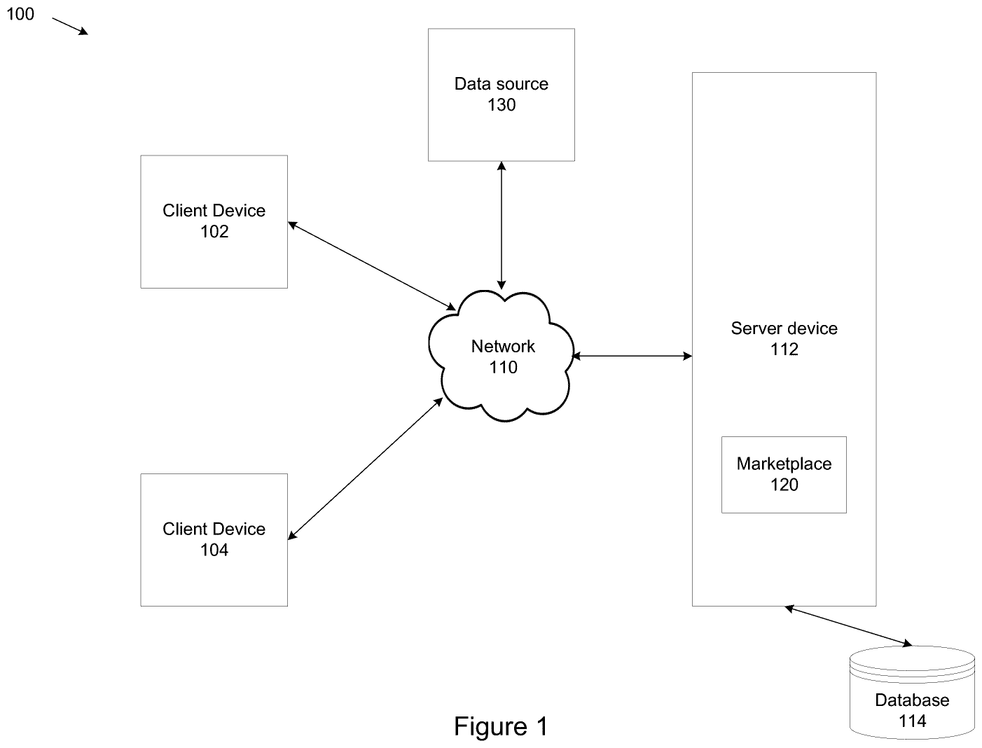

FIG. 1 schematically shows aspects of one example system 100 programmed to provide data provisioning. In this example, the system 100 can be a computing environment that includes a plurality of client and server devices. In this instance, the system 100 includes client devices 102, 104, a server device 112, a database 114, and a data source 130. The client devices 102, 104 can communicate with the server device 112 through a network 110 to accomplish the functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 112 is owned by a financial institution, such as a bank. The client devices 102, 104 can be programmed to communicate with the server device 112 to share and/or consume data.

For example, in one instance, the client device 102 can be programmed to communicate with the server device 112 to perform a financial transaction, such as conduct a risk assessment for a customer wishing to obtain a loan. The client device 102 is programmed to access one or more data sources to obtain data associated with the customer to perform the underwriting for this risk assessment.

In this example, the client device 102 can be provisioned to access the relevant data (e.g., from the data source 130) through the data API provisioning for the system 100. This can, in general terms, include allowing the client device 102 to identify and subscribe to the relevant data source using a marketplace 120 provided by the server device 112. Further, the client device 102 can make relevant data queries to the data source through the APIs provided by the marketplace 120 to obtain the necessary data. Using this information, the client device 102 can provide the required risk assessment for the customer.

The example server device 112 is programmed to provide the data API provisioning functionality described herein. In these examples, the server device 112 and accompanying database 114 create the marketplace 120 of the APIs, allowing for access, authorization, governance, and other functionality associated with providing seamless access to data within the system 100.

In these instances, the marketplace 120 of the server device 112 provides access to authorized data sources, such as the data source 130, for consumption by the client devices 102, 104 of the system 100. The server device 112 can be an API gateway that allows for discovery of the various data sources. In these examples, the client devices 102, 104, which utilize various data platforms like Java, Python, .NET, etc., can subscribe to the desired data sources using a Representational State Transfer (REST) API protocol, although other configurations are possible.

For instance, to access data from the data source 130, the client device 102 can: (i) subscribe to an API through the server device 112 (after proper authentication, authorization, and governance controls are applied) associated with the data source 130; and (ii) call the REST API to gain access to the data from the data source 130. The API defines the proper routing of such a request from the client device 102 to the data source 130, as well as return of the data from the data source 130 to the client device 102. This makes access to the data sources agnostic with respect to the client devices 102, 104 which consume the data.

The example database 114 is programmed to facilitate the functionality associated with the server device 112. This can include housing the marketplace 120 with the APIs. The database 114 can, in some instances, also house one or more of the data sources that are subscribable through the marketplace 120.

The example data source 130 is programmed to provide data to the client devices 102, 104. In this example, the data source 130 can be accessed through the APIs housed in the marketplace 120 of the server device 112. For instance, as described in more detail below, the data source 130 can register with the server device 112. Upon doing so, the marketplace 120 provides a discoverable API that allows the client devices 102, 104 to make requests for data from the data source 130 through the API.

In some examples, the example data source 130 includes a plurality of data sources with data that is consumable. In these examples, the data source 130 can be configured as a Hadoop Distributed File System (HDFS) or a Relational Database Management System (RDBMS). Many other configurations are possible.

The network 110 provides a wired and/or wireless connection between the client devices 102, 104, the data source 130, and the server device 112. In some examples, the network 110 can be a local area network, a wide area network, the Internet, or a mixture thereof. Many different communication protocols can be used. Although only several devices are shown, the system 100 can accommodate hundreds, thousands, or more of computing devices.

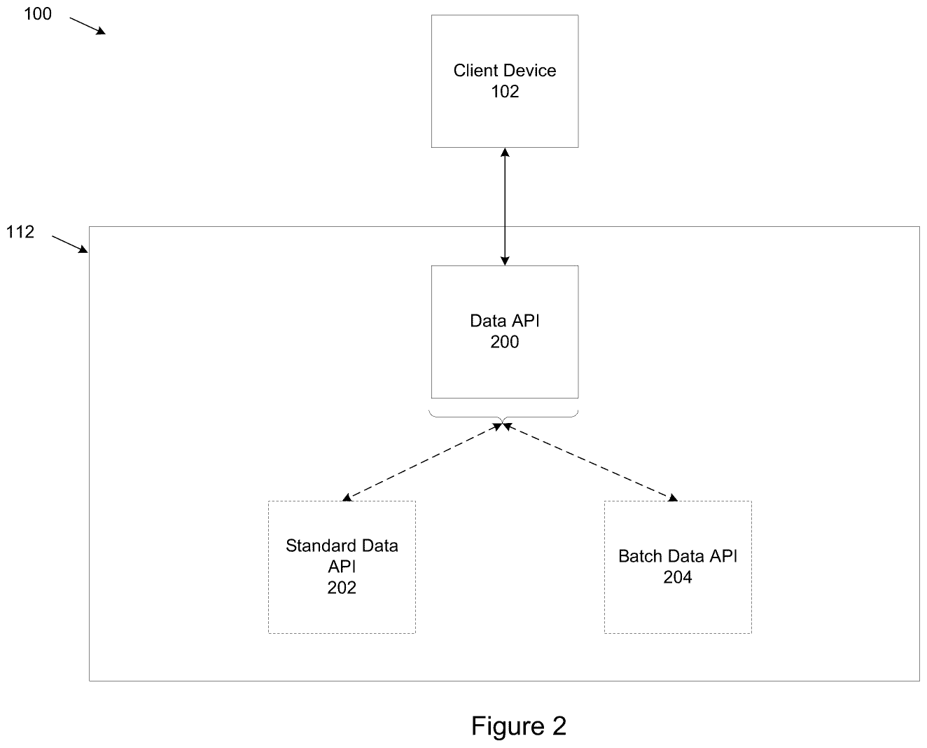

Referring now to FIG. 2, additional details on the data API provisioning are provided. In this example, the client device 102 communicates with the server device 112 to subscribe to a data source. This is accomplished, as described herein, through a data API 200.

In this example, the data API 200 is logically broken into two segments. The server device 112 provides a standard data API 202 and a batch data API 204 associated with the data API 200. These APIs are generally distinguished based upon the amount of data that is requested by the client device 102.

When the data requested is smaller (e.g., less than a given data amount), the standard data API 202 is used to access and provide the requested data immediately. When the data requested is larger (e.g., more than a given data amount), the batch data API 204 is used to access and provide the requested data through a batch process. The client device 102 can select the appropriate API to used based upon the amount of data being requested (and/or the server device 112 can direct the request to the appropriate API based upon the request).

In this example, the standard data API 202 is programmed to return the requested data to the client device 102 through an immediate direct streaming payload. This is typically provided for requests of less than 5 gigabytes of data.

Conversely, the batch data API 204 is programmed to return data through a staged configuration, typically for requests of greater than 5 gigabytes of data. Such requests can be batched and the results staged for the client device 102 to access (when properly authenticated, such as by using an X.509 certificate) when completed. In such an example, an Apache Kafka distributed event store client library can be used. Many alternative configurations are possible.

In some embodiments, the data API 200 can be programmed with additional functionality that filters the data that is returned. This can, for instance, control the data that is returned to a client device and/or allow the client device to define a subset of the data to be returned.

For example, the data API 200 can be programmed to perform column filtering, which is a process where one or more columns of a data set are filtered out based upon the authorization associated with the requesting client device. For instance, if a requesting client device is not authorized to receive one or more columns within a data set, those columns can be left with blank values (or stripped completely) for the returned data set.

In another example, the data API 200 can be programmed to perform row filtering, which is a process where the requesting client device can provide a query parameter with the request that defines a subset of the data for return. In this example, only data within the data set that meets the query parameter is included in the data set that is returned to the requesting client device.

In yet another embodiment, the data API 200 can be programmed to join data sets to serve a request for data. In one example, this can include the data API 200 automatically joining data from data sets into a “super” data set that is available for request through the data API 200. In yet other examples, the data API 200 can be programmed to automatically identify and join data sets that are separately requested. Many configurations are possible.

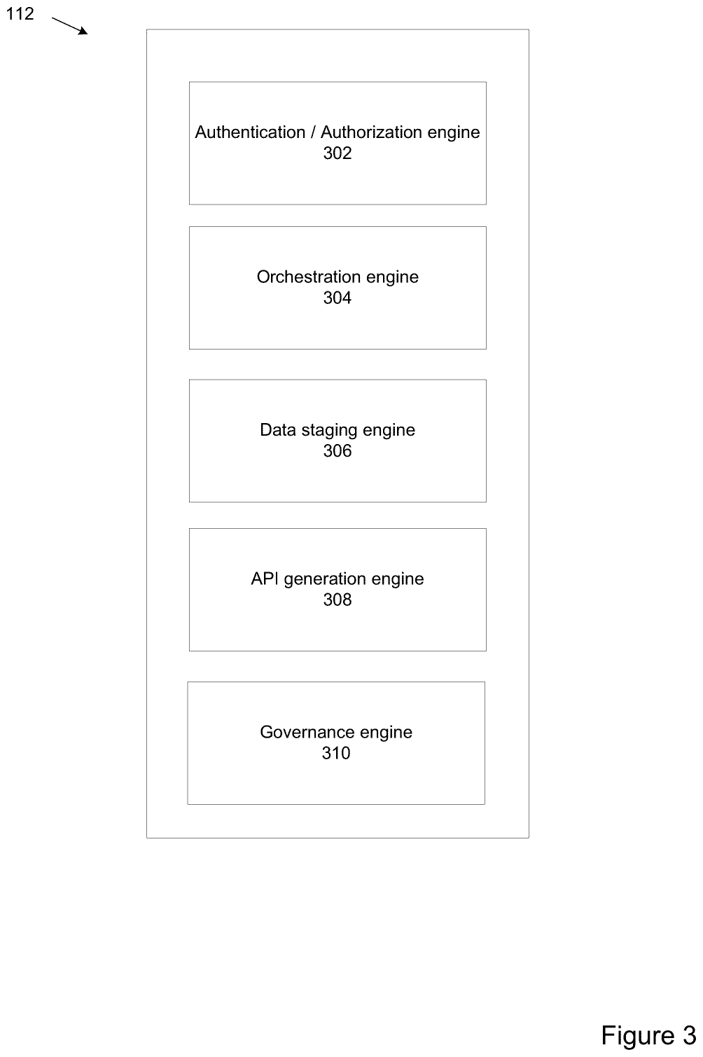

Referring now to FIG. 3, additional details of the server device 112 are shown. In this example, the server device 112 has various logical modules that assist in providing various aspects of the data provisioning. The server device 112 can, in this instance, include an authentication/authorization engine 302, an orchestration engine 304, a data staging engine 306, an API generation engine 308, and a governance engine 310. In other examples, more or fewer engines providing different functionality can be used.

The example authentication/authorization engine 302 is programmed to authenticate and authorize the client devices 102, 104 when requesting data. This can include, without limitation, determining an identity of the client devices 102, 104, determining that the client devices 102, 104 are authorized to access certain data sources, allowing the client devices 102, 104 to subscribe to those data sources in the marketplace 120 of the server device 112, and servicing data requests through the APIs.

The example authentication/authorization engine 302 can also be programmed to provide security for the communications between the client devices 102, 104 and the server device 112, as well as for secure transmission of the data from the data source 130 to the client devices 102, 104. This can include, without limitation, using Transport Layer Security (TLS) and/or mutual TLS (mTLS) for communications between the client devices 102, 104, the server device 112, and the data source 130.

For instance, the client device 102 can register with the marketplace 120 to obtain a client identifier and secret key from the server device 112. Using these, the client device 102 can invoke an API, and the server device 112 can authenticate the client device 102. This authentication can be passed to the data source 130 to obtain the desired data for the client device 102.

Similarly, data can be returned securely from the data source 130 to the client device 102. When larger amounts of data are requested (e.g., through the batch data API 204), an X.509 certificate can be used to secure communications. Many configurations are possible.

The example orchestration engine 304 is programmed to facilitate this data access process. As noted, the orchestration engine 304 can receive a data access request through an API, determine the best route to the data source 130, and facilitate the transfer of the requested data from the data source 130 to the requesting client devices 102, 104.

The example data staging engine 306 is programmed to control staging when large amounts of data are requested by the client device 102. For instance, when the batch data API 204 is utilized, data can be stored in a staging area by the server device 112, and the client device 102 can thereupon access the data from the staging area.

The example API generation engine 308 is programmed to allow for the creation of new APIs within the marketplace 120 of the server device 112. In such an example, the data source 130 provides metadata associated with the data from the data source 130, and the server device 112 is programmed to create an API within the marketplace 120 to allow for access to the data source 130 by the client devices 102, 104.

Generally, the marketplace 120 can be built using an up-to-date view of metadata, including the collection of technical/business metadata and operational metadata. The marketplace 120 can use this metadata to organize the APIs and provide operational access to the data from the data sources associated with the APIs.

In such an example, the server device 112 allows the data source 130 to register with the marketplace 120. This process can include the data source 130 providing metadata associated with the data of the data source 130, such as the type of data, how the data is organized, description of the data, etc. The data source 130 can also provide metadata associated with the lineage of the data, such as the sourcing of the data, how the data relates to other data, etc. The metadata can also include information on how the data can be accessed, such as the protocols used, addressing information, etc.

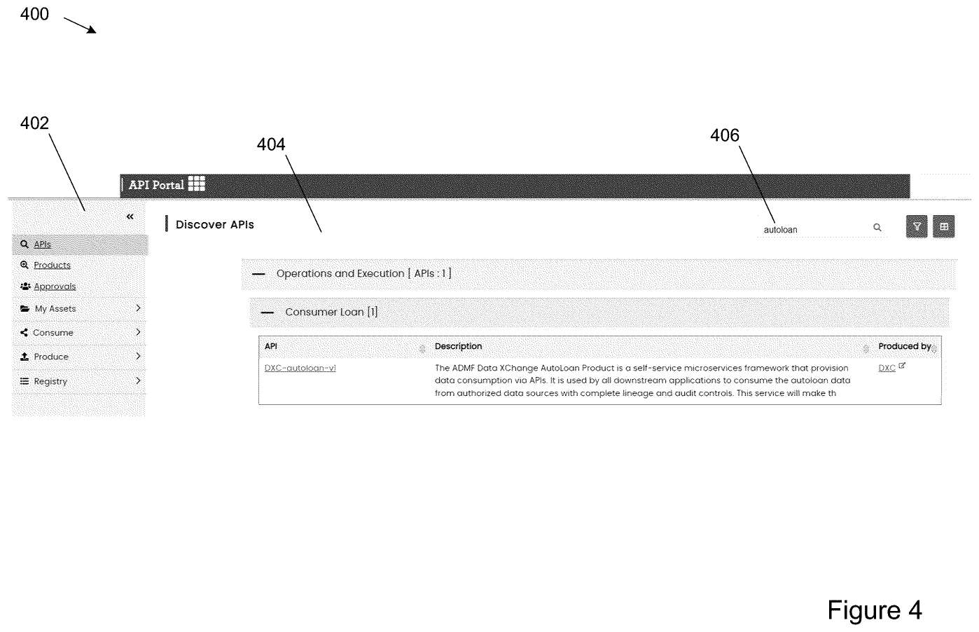

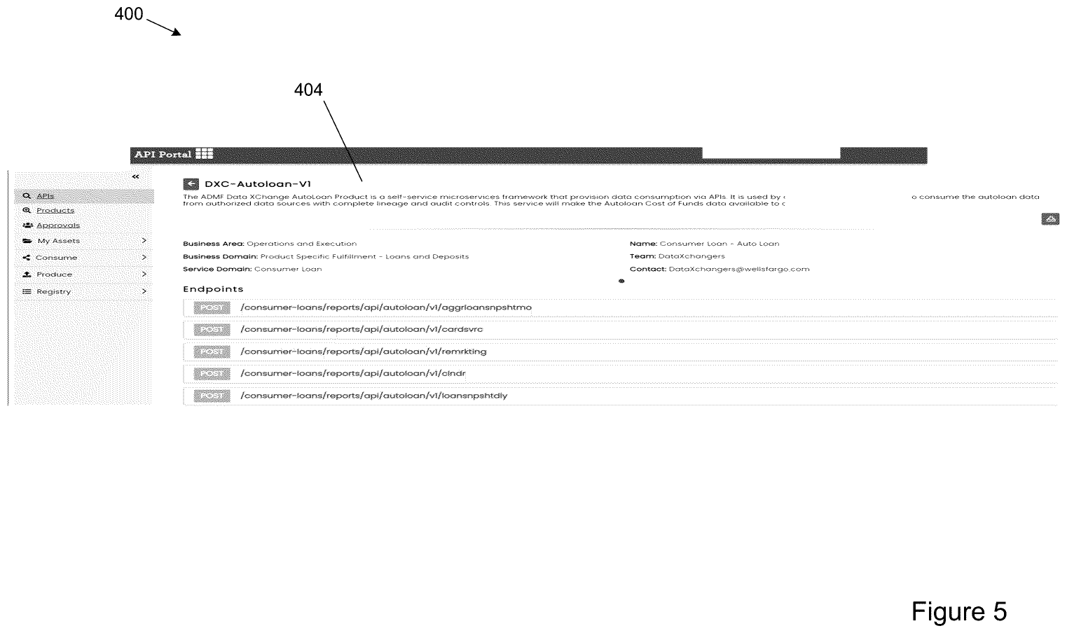

The server device 112 uses this metadata to create one or more discoverable APIs in the marketplace 120 that are used to access the data from the data source 130. Once available, the client device 102 can discover the relevant API on the marketplace 120 (see FIGS. 4-5 described below), register with the API, and make requests for data from the data source 130 through the API.

The example governance engine 310 is programmed to collect data governance metadata (e.g., technical metadata, data lineage, data controls) while interacting with the data sources, such as the data source 130. The governance engine 310 can be programmed to provide access to this governance information for discovery and consumption. The governance engine 310 can also be programmed to work in concert with the authentication/authorization engine 302 to assure that certain governance standards are met as client devices access data sources.

In this example, the governance engine 310 can provide an automated data management framework that provides controls for the various information that is shared by the server device 112, such as the metadata and lineage of the data. Advantageously, these controls can be applied centrally within the marketplace 120 and allow for standardization across the system 100.

Finally, the governance engine 310 can also be programmed to validate the accuracy of a given data against the metadata and other information provided by the producer of the data set. For instance, the governance engine 310 can be programmed to receive a schema associated with the data set and confirm that the data provided by the data API 200 conforms to that schema. Many configurations are possible.

Referring now to FIGS. 4-5, an example graphical user interface 400 presents information associated with the marketplace 120 so that desired APIs can be discovered.

In this example, the interface 400 includes a menu bar 402 with selectable options. The “APIs” entry is selected to obtain a list of the APIs that are available from the marketplace 120.

A main area 404 of the interface 400 shows information about the APIs. In this example, the APIs are listed in a hierarchy to allow for easier identification of relevant APIs. Further, a search box 406 can be used to filter the APIs shown in the main area 404. In this example, an example term “autoloan” is used to filter the APIs to a single API shown.

The example API shown in the main area 404 (“DXC-autoloan-v1”) includes the hierarchy associated with the API (e.g., “Operations and Execution”/“Consumer Loan”), along with a description of the data that is available using the API. In this case, the data is associated with automobile loans.

As illustrated in FIG. 5, upon receiving selection of the listed API, the main area 404 provides additional details about the API. These details can include, without limitation, additional information about the data, including a more detailed description of the data in the data source, along with a list of the API endpoints for the data source.

Using the interface 400, the consumer can select the desired API for subscription. Further, additional interfaces can be provided to allow for maintenance of the APIs, including approval by the data source owners and controls for access to the APIs, including governance considerations. Many other configurations are possible.

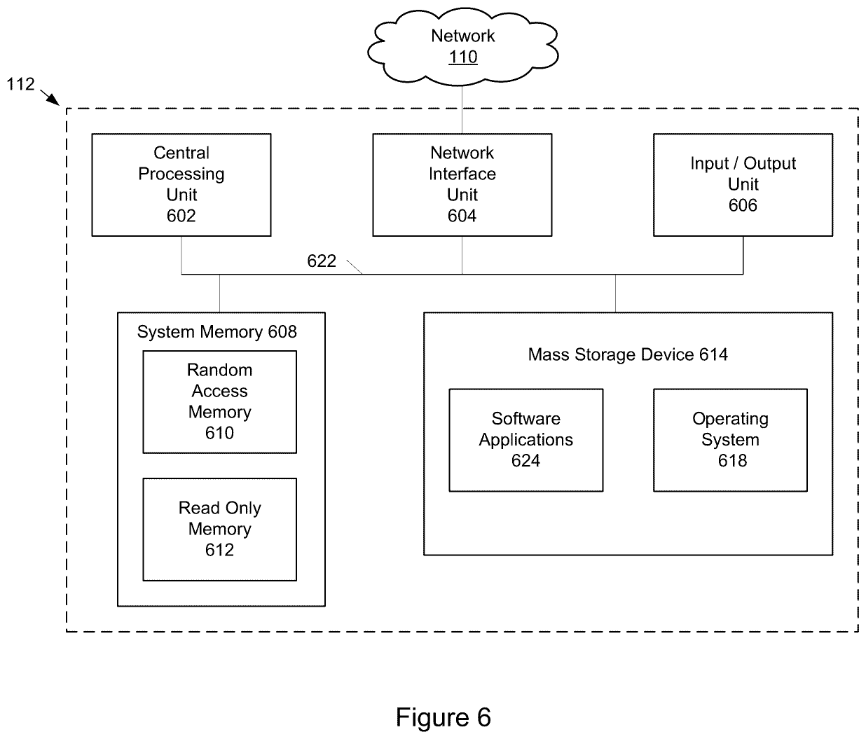

As illustrated in the embodiment of FIG. 6, the example server device 112, which provides the functionality described herein, can include at least one central processing unit (“CPU”) 602, a system memory 608, and a system bus 622 that couples the system memory 608 to the CPU 602. The system memory 608 includes a random access memory (“RAM”) 610 and a read-only memory (“ROM”) 612. A basic input/output system containing the basic routines that help transfer information between elements within the server device 112, such as during startup, is stored in the ROM 612. The server device 112 further includes a mass storage device 614. The mass storage device 614 can store software instructions and data. A central processing unit, system memory, and mass storage device like that shown can also be included in the other computing devices disclosed herein.

The mass storage device 614 is connected to the CPU 602 through a mass storage controller (not shown) connected to the system bus 622. The mass storage device 614 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 604 connected to the system bus 622. It should be appreciated that the network interface unit 604 may also be utilized to connect to other types of networks and remote computing systems. The server device 112 also includes an input/output controller 606 for receiving and processing input from a number of other devices, including a touch user interface display screen or another type of input device. Similarly, the input/output controller 606 may provide output to a touch user interface display screen or other output devices.

As mentioned briefly above, the mass storage device 614 and the RAM 610 of the server device 112 can store software instructions and data. The software instructions include an operating system 618 suitable for controlling the operation of the server device 112. The mass storage device 614 and/or the RAM 610 also store software instructions and applications 624, that when executed by the CPU 602, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

1. A computer system for provisioning data, comprising:
one or more processors; and
non-transitory computer-readable storage media encoding instructions which, when executed by the one or more processors, causes the computer system to create:
a marketplace programmed to provide a plurality of application programming interfaces (APIs) for available data sources, the APIs being subscribable for client devices;
an authentication engine programmed to control access by the client devices to the APIs in the marketplace; and
an orchestration engine programmed to facilitate one client device of the client devices subscribing to one of the plurality of APIs by receiving a data request from the one client device and directing the data request to a standard data API for smaller data requests and a batch data API for larger data requests by the one client device.

2. The computer system of claim 1, wherein the marketplace includes a user interface that lists information about each of the plurality of APIs.

3. The computer system of claim 1, wherein the marketplace captures technical and operational metadata associated with the plurality of APIs.

4-5. (canceled)

6. The computer system of claim 1, comprising further instructions which, when executed by the one or more processors, causes the computer system to create a data staging engine programmed to stage data returned using the batch data API.

7. The computer system of claim 1, wherein the orchestration engine is further programmed to perform column filtering or row filtering on a data set.

8. The computer system of claim 1, comprising further instructions which, when executed by the one or more processors, causes the computer system to create a governance engine programmed to provide governance controls associated with the plurality of APIs, wherein the governance controls are centrally auditable for the computer system, and wherein the governance engine performs validation on a data set.

9. The computer system of claim 1, comprising further instructions which, when executed by the one or more processors, causes the computer system to create an API generation engine programmed to create additional APIs in the marketplace.

10. The computer system of claim 9, wherein the API generation engine is programmed to receive metadata associated with a new API from an owner of a data source, the metadata including lineage information for data from the data source.

11. A method for provisioning data, comprising:
providing a marketplace programmed to include a plurality of application programming interfaces (APIs) for available data sources, the APIs being subscribable for client devices; and
controlling access by the client devices to the APIs in the marketplace, and
providing a standard data API for smaller data requests and a batch data API for larger data requests.

12. The method of claim 11, wherein the marketplace includes a user interface that lists information about each of the plurality of APIs.

13. The method of claim 11, wherein the marketplace captures technical and operational metadata associated with the plurality of APIs.

14. The method of claim 11, further comprising facilitating one client device of the client devices subscribing to one of the plurality of APIs.

15. (canceled)

16. The method of claim 11, further comprising staging data returned using the batch data API.

17. The method of claim 11, further comprising providing governance controls associated with the plurality of APIs.

18. The method of claim 17, wherein the governance controls are centrally auditable for the method.

19. The method of claim 11, further comprising creating additional APIs in the marketplace.

20. The method of claim 19, further comprising receiving metadata associated with a new API from an owner of a data source, the metadata including lineage information for data from the data source.
